(19) United States
(12) Patent Application Publication
(10) Pub. No.: US 2003/0011691 A1
(43) Pub. Date: Jan. 16, 2003

(54) Camera-mounted apparatus and data writing control method for the same

(76) Inventor: Atsushi Nagao, Fussa-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/192,165

(22) Filed: Jul. 11, 2002

(30) Foreign Application Priority Data
Jul. 12, 2001 (JP) 2001-212482

(51) Int. Cl. H04N 5/76; H04N 5/232; H04N 7/00

(52) U.S. Cl. 348/231.99; 348/211.14; 348/552

(57) ABSTRACT

A camera-mounted apparatus comprises a camera module and a controller. The camera module includes an imaging sensor which captures an image of an object, a signal processor which processes image data captured by the imaging sensor, and a buffer memory which stores at least one frame of image data processed by the signal processor. The controller carries out control of the camera module. The signal processor prohibits writing operation of the image data into the buffer memory while the controller reads out the image data from the buffer memory.

### CROSS-REFERENCE TO RELATED APPLICATIONS

This application is based upon and claims the benefit of priority from the prior Japanese Patent Application No. 2001-212482, filed Jul. 12, 2001, the entire contents of which are incorporated herein by reference.

### BACKGROUND OF THE INVENTION

1. Field of the Invention

The present invention relates to a camera-mounted apparatus and a data writing control method for the same.

2. Description of the Related Art

A typical camera-mounted apparatus is an apparatus in which a small-sized camera is mounted on a mobile terminal such as a mobile telephone or a mobile-type computer, and processings such as displaying image data captured by the camera on a displaying section are carried out by a processor governing control of the entire device.

Further, the camera of such a camera-mounted apparatus is mainly structured from an imaging sensor for imaging an object, and a signal processing section. The signal processing section receives image data captured by the imaging sensor, converts the image data into a digital signal, and transmits it to the processor.

An interface between the signal processing section and the processor of such a camera-mounted apparatus is preferably a generally-used interface in order to be able to access the camera by a generally-used processor.

However, there are many cases in which the interface between the signal processing section and the processor is structured from a vertical synchronization (VSYNC), a horizontal synchronization (HSYNC), a synchronous clock (PCLK), and a data bus (an exclusive bus of 8/16 bits of YUV or RGB). In this case, an exclusive interface circuit must be provided at the processor side, and the image data is transferred as a stream from the signal processing section unrelated to the operation timing of the processor. Therefore, constraints on the operation of the processor increase.

On the other hand, when not an exclusive interface, but a generally-used interface is used, there is no need to provide an exclusive interface circuit at the processor side. However, because the processor must carry out extra processings, the constraints on the operation have not been improved.

In this case, by using methods such as DMA (Direct Memory Access), FIFO (First In First Out), or the like, constraints on the operation of the processor can be decreased. However, there is the need to provide extra hardware, which leads to the device becoming complicated.

### BRIEF SUMMARY OF THE INVENTION

Accordingly, an object of the present invention is to provide a camera-mounted apparatus which solves the drawbacks described above, and which has a generally-used interface and does not impose constraints on the operation of a processor.

Another object of the present invention is to provide a data writing control method for a camera-mounted apparatus which solves the drawbacks described above, and which has a generally-used interface and does not impose constraints on the operation of a processor.

In order to achieve the above object, according to a first aspect of the present invention, there is provided a camera-mounted apparatus comprising:

a camera module including an imaging sensor which captures an image of an object, a signal processor which processes image data captured by the imaging sensor, and a buffer memory which stores at least one frame of image data processed by the signal processor; and

a controller which carries out control of the camera module,

wherein the signal processor prohibits writing operation of the image data into the buffer memory while the controller reads out the image data from the buffer memory.

A second aspect of the present invention relates to a camera-mounted apparatus according to the first aspect of the present invention, wherein the signal processor prohibits writing of the image data into the buffer memory when the signal processor receives a writing stop command from the controller, and restarts writing of image data into the buffer memory when the signal processor receives a writing restart command from the controller.

A third aspect of the present invention relates to a camera-mounted apparatus according to the second aspect of the present invention, wherein when the signal processor receives the writing stop command from the controller, the signal processor carries out writing up to the end of the frame and one frame of image data stored in the buffer memory is held until receipt of the writing restart command from the controller.

A fourth aspect of the present invention relates to a camera-mounted apparatus according to the second aspect of the present invention, wherein the signal processor outputs a signal to the controller, the signal representative of whether the camera module can be accessed or not during the receipt of the writing stop command and the receipt of the writing restart command from the controller.

A fifth aspect of the present invention relates to a camera-mounted apparatus according to the first aspect of the present invention, wherein while the controller reads out the image data from the buffer memory, the signal processor can be operated independently of the controller, and signal processings such as automatic exposure (AE) and automatic white balance (AWB) are carried out.

A sixth aspect of the present invention relates to a camera-mounted apparatus according to the first aspect of the present invention, wherein control of the signal processor and detection of the state of the signal processor, and reading out of image data from the buffer memory are carried out by a generally-used interface.

According to a seventh aspect of the present invention, there is provided a data writing control method for a camera-mounted apparatus comprising a camera module including an imaging sensor which captures an image of an object, a signal processor which processes image data captured by the imaging sensor, and a buffer memory which stores at least one frame of image data processed by the signal processor; and a controller which carries out control of the camera module,

starting an imaging operation by the imaging sensor and the signal processor so as to capture image data;

writing the captured image data into the buffer memory; and

prohibiting the writing operation of the image data into the buffer memory while the controller reads out the image data from the buffer memory.

An eighth aspect of the present invention relates to a data writing control method according to the seventh aspect of the present invention, wherein the signal processor prohibits writing of the image data into the buffer memory when the signal processor receives a writing stop command from the controller, and restarts writing of image data into the buffer memory when the signal processor receives a writing restart command from the controller.

A ninth aspect of the present invention relates to a data writing control method according to the eighth aspect of the present invention, wherein when the signal processor receives the writing stop command from the controller, the signal processor carries out writing up to the end of the frame and one frame of image data stored in the buffer memory is held until receipt of the writing restart command from the controller.

A tenth aspect of the present invention relates to a data writing control method according to the eighth aspect of the present invention, wherein the signal processor outputs a signal to the controller, the signal representative of whether the camera module can be accessed or not during the receipt of the writing stop command and the receipt of the writing restart command from the controller.

An eleventh aspect of the present invention relates to a data writing control method according to the seventh aspect of the present invention, wherein while the controller reads out the image data from the buffer memory, the signal processor can be operated independently of the controller, and signal processings such as automatic exposure (AE) and automatic white balance (AWB) are carried out.

A twelfth aspect of the present invention relates to a data writing control method according to the seventh aspect of the present invention, wherein control of the signal processor and detection of the state of the signal processor, and reading out of image data from the buffer memory are carried out by a generally-used interface.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is a block diagram showing a schematic configuration of a camera-mounted apparatus according to an embodiment of the present invention; and

FIG. 2 is a timing chart showing timing when a processor reads out data stored in a buffer memory of a camera module.

### DETAILED DESCRIPTION OF THE INVENTION

Hereinafter, an embodiment of the present invention will be described with reference to the figures.

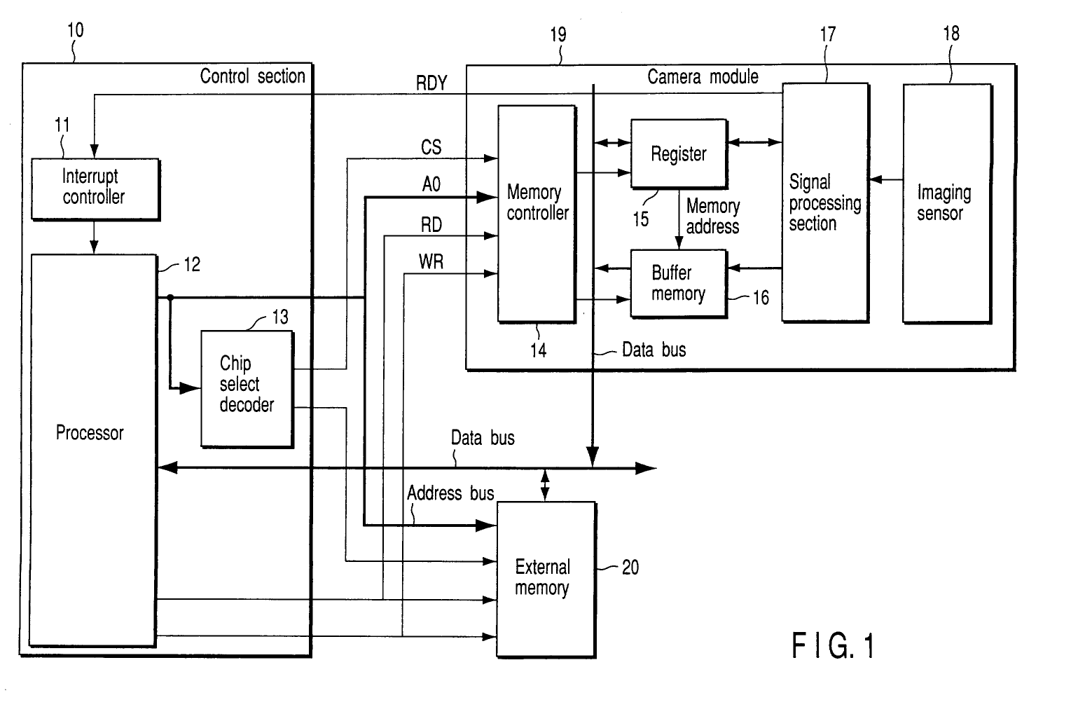

FIG. 1 is a block diagram showing a schematic configuration of a camera-mounted apparatus according to the embodiment of the present invention. As shown in the figure, a control section 10 has an interrupt controller 11, a processor 12, and a chip select decoder 13, and an external memory 20 is connected to the control section 10. Further, the control section 10 and a camera module 19 controlled by the control section 10 are connected to one another by a generally-used interface to be described later.

The chip select decoder 13 selects one of access to the camera module 19 and the external memory 20 on the basis of an address signal from the processor 12.

Further, the chip select decoder 13 transmits a chip selecting signal (CS) to a memory controller 14 in order to switch access to a register 15 and a buffer memory 16 in the camera module 19.

As the access from the processor 12 to the camera module 19, there are the three cases of:

1. command writing for carrying out control of a signal processing section 17;

2. status reading for knowing a state of the signal processing section 17; and

3. data reading for reading out the contents of the buffer memory 16.

In the present embodiment, due to all of these accesses being carried out via the generally-used interface, the number of signal lines necessary for accessing is decreased.

On the other hand, the camera module 19 has an imaging sensor 18 which captures an image of an object, the signal processing section 17 which processes image data captured by the imaging sensor 18, the buffer memory 16 which stores image data of at least one frame, the register 15 which provides a memory address to the buffer memory 16, and the memory controller 14 which controls reading operation and writing operation for the buffer memory 16 and the register 15.

Hereinafter, a generally-used interface will be described.

In the present embodiment, the processor 12 and the memory controller 14 are connected by three signal lines of an address, a read, a write, and respective requests of address writing, command writing, status reading, and data reading are distinguished by the three lines.

Accordingly, in addition to a generally-used interface formed from a chip select (CS), a read (RD), a write (WD), an address (AO), and a data bus, if a ready (RDY) signal indicating the state of access to the buffer memory 16 of the signal processing section 17 is provided, the control section 10 can carry out various types of control for the camera module 19.

Note that, with respect to the aforementioned command writing and status reading, because it is necessary to designate the address of the register 15, the command writing and the status reading are used as a set together with the address writing cycle. Further, a memory address at the time of the aforementioned data reading is designated by a command, and high speed reading is made be possible by carrying out automatic incrementation each time data reading occurs.

While the signal processing section 17 is writing image data into the buffer memory 16, the RDY signal is in a state of disable, and notification is given to the processor 12 that access to the camera module 19 is impossible. Further, writing of data into the buffer memory 16 is operated in accordance with frame rates of the imaging sensor 18 and the signal processing section 17, and does not depend on the speed of processing of the control section 10.

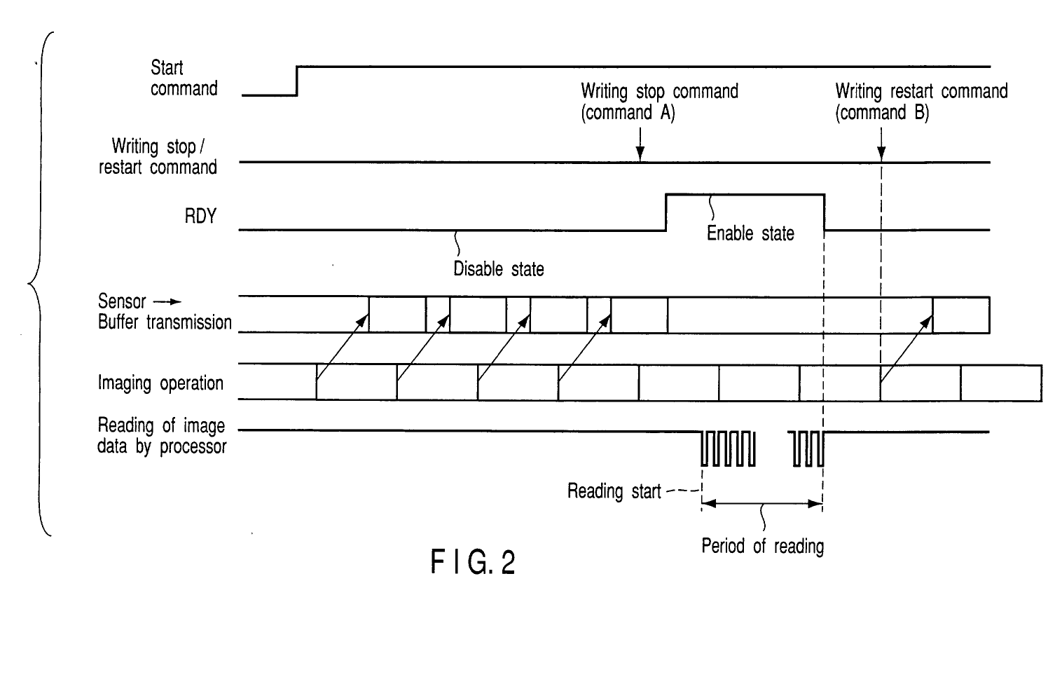

FIG. 2 is a timing chart showing the timing when the processor 12 reads out the image data stored in the buffer memory 16 of the camera module 19.

Firstly, the imaging sensor 18 and the signal processing section 17 of the camera module 19 start operation of imaging when the signal level of the start command (command writing) from the processor 12 shifts to the upper level. The image data captured by imaging an object is transferred to and written into the buffer memory 16. During this series of operations, the RDY signal is in a disable state.

When the processor 12 reads out the image data stored in the buffer memory 16, the processor 12 transmits a memory writing stop command (command A) to the signal processing section 17. When the signal processing section 17 receives command A, the signal processing section 17 carries out writing up to the end of the frame for which writing is currently being carried out. At the time when the writing is completed, the RDY signal is set to be in an enable state, and the writing operation is prohibited.

The processor 12 monitors the RDY signal. When the processor 12 detects that the RDY signal has been set to the enable state, the processor 12 starts reading of image data of one frame from the buffer memory 16.

In this example, the bus width of the data bus is 8 bits, and on the other hand, one pixel of image data to be read is structured from 16 bits. Therefore, in order to read data of one pixel, two reading operations are carried out.

When the RDY signal is once set to the enable state, image data of one pixel written in the buffer memory 16 is held until receipt of a writing restart command (command B) from the processor 12. Accordingly, after the RDY signal has been set to the enable state, the processor 12 can carry out reading of image data at a desired timing.

Further, while the writing of the image data into the buffer memory 16 is being prohibited, the signal processing section 17 can be operated independently of the processor 12. Processings such as automatic exposure (AE), automatic white balance (AWB) and the like are carried out on the data received from the imaging sensor 18, and the results are written in the buffer memory 16.

In this way, even if the speed of the processor 12 reading data from the buffer memory 16 is slow, the signal processing section 17 can precisely carry out the controls of AE and AWB so as to match the actual state.

Because the buffer memory 16 has memory of at least one frame, by controlling the writing operation to the buffer memory 16, signal processings such as expansion, reduction, rotation, mirror-imaging and the like can be carried out without burdening the processor 12.

The processor 12 monitors the number of readings while the reading of image data of one frame from the buffer memory 16 is being carried out. When reading of image data by a number of times corresponding to the image data of one frame is completed, the processor 12 judges that the reading operation is completed. In the same way, the signal processing section 17 monitors the number of readings while the processor 12 is carrying out reading of image data from the buffer memory 16. When reading of image data by a number of times corresponding to the image data of one frame is completed, the signal processing section 17 judges that the reading operation is completed. After that, the signal processing section 17 changes the RDY signal to a disable state. The processor 12, which detects the disable state, outputs a writing restart command (command B) to the signal processing section 17. The signal processing section 17, when receiving the writing restart command (command B), restarts imaging operation and transmission of the image data captured by the imaging operation to the buffer memory 16.

Note that, in the above description, at the time when the processor 12 completes reading of image data from the buffer memory 16, the signal processing section 17 changes the RDY signal to a disable state. However, when the writing restart command (command B) from the processor 12 is detected after reading of image data is completed, the RDY signal of the signal processing section 17 may be changed to a disable state.

If a situation arises in which the reading operation must be ended in the midst of carrying out reading of image data of one frame by the processor 12, the writing restart command (command B) is transferred to the signal processing section 17.

Further, in the above description, the general contents of a camera-mounted apparatus were described. However, the constitution of the present invention may be applied to, for example, a mobile telephone.

When the processor 12 carries out control of a mobile telephone, because controls relating to functions other than the processing of image data, such as telephone functions and the like, must be carried out, cases arise in which it is difficult to process image data synchronously with the imaging operation of the camera module 19, and, depending on the case, it may not be possible to fetch desired image data.

However, in accordance with the constitution of the present invention, image data of one frame which is imaged by the camera module 19 is written in the buffer memory 16, and the processor 12 can read out the image data at a desired timing. Therefore, the image data can be processed without being affected by the state of operation of the processor 12.

In accordance with the present invention, a camera module has a buffer memory which stores image data of at least one frame. Therefore, even if there are times when a processor cannot read out image data due to real time processing, there is no overlooking of image data, and the image data can be read at a desired timing.

Further, in accordance with the present invention, because a generally-used interface is used for reading data from the camera module, the image data of the camera module can be read without using an exclusive interface or a special hardware at the processor side.

Further, in accordance with the present invention, because control of the signal processing section and detection of the state of the signal processing section of the camera module, and reading of image data from the buffer memory are carried out by the generally-used interface, the interface signal between the processor and the camera module can be kept as small as possible.

Further, in accordance with the present invention, even if reading processing of the image data is at low speed due to constraints on the speed of operation of the processor, feedback controls such as AE, AWB and the like can be carried out at high speed, separate from the processing.

Moreover, image processings such as expansion, reduction, rotation, mirror-imaging and the like can be carried out without burdening the processor.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A camera-mounted apparatus comprising:
a camera module including an imaging sensor which captures an image of an object, a signal processor which processes image data captured by the imaging sensor, and a buffer memory which stores at least one frame of image data processed by the signal processor; and
a controller which carries out control of the camera module,
wherein the signal processor prohibits writing operation of the image data into the buffer memory while the controller reads out the image data from the buffer memory.

2. A camera-mounted apparatus according to claim 1, wherein the signal processor prohibits writing of the image data into the buffer memory when the signal processor receives a writing stop command from the controller, and restarts writing of image data into the buffer memory when the signal processor receives a writing restart command from the controller.

3. A camera-mounted apparatus according to claim 2, wherein when the signal processor receives the writing stop command from the controller, the signal processor carries out writing up to the end of the frame and one frame of image data stored in the buffer memory is held until receipt of the writing restart command from the controller.

4. A camera-mounted apparatus according to claim 2, wherein the signal processor outputs a signal to the controller, the signal representative of whether the camera module can be accessed or not during the receipt of the writing stop command and the receipt of the writing restart command from the controller.

5. A camera-mounted apparatus according to claim 1, wherein while the controller reads out the image data from the buffer memory, the signal processor can be operated independently of the controller, and signal processings such as automatic exposure (AE) and automatic white balance (AWB) are carried out.

6. A camera-mounted apparatus according to claim 1, wherein control of the signal processor and detection of the state of the signal processor, and reading out of image data from the buffer memory are carried out by a generally-used interface.

7. A data writing control method for a camera-mounted apparatus comprising a camera module including an imaging sensor which captures an image of an object, a signal processor which processes image data captured by the imaging sensor, and a buffer memory which stores at least one frame of image data processed by the signal processor; and a controller which carries out control of the camera module,
starting an imaging operation by the imaging sensor and the signal processor so as to capture image data;
writing the captured image data into the buffer memory; and
prohibiting the writing operation of the image data into the buffer memory while the controller reads out the image data from the buffer memory.

8. A camera-mounted apparatus according to claim 7, wherein the signal processor prohibits writing of the image data into the buffer memory when the signal processor receives a writing stop command from the controller, and restarts writing of image data into the buffer memory when the signal processor receives a writing restart command from the controller.

9. A camera-mounted apparatus according to claim 8, wherein when the signal processor receives the writing stop command from the controller, the signal processor carries out writing up to the end of the frame and one frame of image data stored in the buffer memory is held until receipt of the writing restart command from the controller.

10. A camera-mounted apparatus according to claim 8, wherein the signal processor outputs a signal to the controller, the signal representative of whether the camera module can be accessed or not during the receipt of the writing stop command and the receipt of the writing restart command from the controller.

11. A camera-mounted apparatus according to claim 7, wherein while the controller reads out the image data from the buffer memory, the signal processor can be operated independently of the controller, and signal processings such as automatic exposure (AE) and automatic white balance (AWB) are carried out.

12. A camera-mounted apparatus according to claim 7, wherein control of the signal processor and detection of the state of the signal processor, and reading out of image data from the buffer memory are carried out by a generally-used interface.
